(19) United States
(12) Patent Application Publication
(10) Pub. No.: US 2024/0052504 A1
(43) Pub. Date: Feb. 15, 2024

(54) COATED MEMBRANE FOR WATER ELECTROLYSIS

(71) Applicants: Greenerity GmbH, Alzenau (DE); Heraeus Deutschland GmbH & Co. KG, Hanau (DE); Technische Universität München, München (DE)

(72) Inventors: Christian GEBAUER, Hanau (DE); Martina KEMMER, Hanau (DE); Hubert GASTEIGER, München (DE); Maximilian BERNT, München (DE); Alexandra HARTIG-WEISS, Heilsbronn (DE); Jan BYRKNES, Bad Vilbel (DE); Christian EICKES, Frankfurt am Main (DE); Alessandro GHIELMI, Frankfurt am Main (DE)

(73) Assignees: Greenerity GmbH, Alzenau (DE); Heraeus Deutschland GmbH & Co. KG, Hanau (DE); Technische Universität München, München (DE)

(21) Appl. No.: 18/269,359

(22) PCT Filed: Dec. 22, 2021
(86) PCT No.: PCT/EP2021/087208

§ 371 Date: Jun. 23, 2023

(30) Foreign Application Priority Data
Dec. 23, 2020 (EP) 20217070.0

(51) Int. Cl. C25B 9/23; C25B 11/075; C25B 11/054; C25B 13/08; C25B 11/067

(52) U.S. Cl. CPC C25B 9/23; C25B 11/075; C25B 11/054; C25B 13/08; C25B 11/067

(57) ABSTRACT

The present invention relates to a coated membrane containing:
a membrane with a front and a rear face,
a catalyst-containing coating which is provided on the front face of the membrane,
the catalyst containing
a support material which has a BET surface area of maximally 80 m²/g,
an iridium-containing coating which is provided on the support material and contains an iridium oxide, an iridium hydroxide or an iridium hydroxide oxide or a mixture of at least two of these iridium compounds,
wherein the catalyst contains iridium in a quantity of maximally 60 wt. %, and
the coating provided on the membrane front face has an iridium content of maximally 0.4 mg iridium/cm².

The present invention relates to a coated membrane which can be used as a membrane electrode assembly for water electrolysis.

Hydrogen is considered to be the energy carrier of the future, since it enables sustainable energy storage, is available long-term, and can also be produced using renewable energy technologies.

Currently, steam reforming is the most common process for preparing hydrogen. In steam reforming, methane and water vapor are converted to hydrogen and CO. Water electrolysis constitutes a further variant of hydrogen production. Hydrogen can be obtained in high purity via water electrolysis.

There are various methods of water electrolysis, in particular alkaline water electrolysis, acidic water electrolysis using a polymer electrolyte membrane (“PEM”; PEM water electrolysis) and high-temperature solid oxide electrolysis.

A water electrolysis cell contains a half-cell comprising an electrode at which the oxygen evolution reaction (“OER”), takes place, and a further half-cell comprising an electrode at which the hydrogen evolution reaction (“HER”) takes place. The electrode at which the oxygen evolution reaction takes place is referred to as the anode.

An overview of the technology of water electrolysis, in particular PEM water electrolysis, can be found, for example, in M. Carmo et al., International Journal of Hydrogen Energy, 38, 2013, pp. 4901-4934; and V. Himabindu et al., Materials Science for Energy Technologies, 2, 2019, pp. 442-454.

In the case of a polymer electrolyte membrane water electrolysis cell (also referred to below as PEM water electrolysis cell), the polymer membrane functions as a proton transport medium and electrically isolates the electrodes from one another. The catalyst compositions for the oxygen evolution reaction and the hydrogen evolution reaction are applied, for example, as anode and cathode to the front and rear faces of the membrane (“Catalyst-Coated Membrane CCM”), so that a membrane electrode assembly is obtained (“MEA”).

The oxygen evolution reaction occurring at the anode of a PEM water electrolysis cell can be described by the following reaction equation:

2H₂O→4H⁺+O₂+4 e⁻

Due to its complex reaction mechanism, the oxygen evolution reaction has slow reaction kinetics, which is why a significant excess potential is required at the anode in order to achieve sufficiently high conversion rates. In addition, the oxygen evolution reaction proceeds under very acidic conditions (i.e. low pH).

The efficient operation of a water electrolysis cell requires the presence of catalysts. Since the oxygen evolution reaction at the anode proceeds under very corrosive conditions (low pH, significant overvoltage), in particular noble metals such as ruthenium and iridium, and the oxides thereof, are possible as suitable catalyst materials.

The catalytically active metals or metal oxides can optionally be provided on a support material in order to thus increase the specific surface area of the catalyst material.

For the support materials too, only those materials which have a sufficiently high stability under the very corrosive conditions of the oxygen evolution reaction, for example transition metal oxides such as TiO₂ or oxides of certain main group elements such as Al₂O₃, are possible. However, many of these oxidic support materials are electrically non-conductive, which has a disadvantageous effect on the efficiency of the oxygen evolution reaction and thus also of the water electrolysis.

An overview of catalysts for the oxygen evolution reaction under acidic conditions (i.e. at the anode of a PEM water electrolysis cell) can be found, for example, in P. Strasser et al., Adv. Energy Mater., 7, 2017, 1601275; and F. M. Sapountzi et al., Progress in Energy and Combustion Science, 58, 2017, pp. 1-35.

WO 2005/049199 A1 describes a catalyst composition for the oxygen evolution reaction in PEM water electrolysis. This catalyst contains iridium oxide and an inorganic oxide acting as a support material. The support material has a BET surface area in the range of 50 m²/g to 400 m²/g and is provided in the composition in a quantity of less than 20 wt. %. Thus, the catalyst composition has a high iridium content.

The deposits of iridium are quite limited. In the publications by M. Bernt et al., “Analysis of Voltage Losses in PEM Water Electrolyzers with Low Platinum Group Metal Loadings”, J. Electrochem. Soc. 165, 2018, F305-F314, and M. Bernt et al., “Current Challenges in Catalyst Development for PEM Water Electrolyzers”, Chem. Ing. Tech., 2020, 92, no. 1-2, pp. 31-39, it is mentioned that a currently usual iridium content level on the anode side of the catalyst-coated membrane is about 2 mg iridium per cm 2 coated membrane surface, but this content level must still be significantly reduced in order to enable a large-scale use of PEM electrolysis based on the available iridium quantity. The target value for the iridium content level per unit area is specified as 0.05 mg iridium per cm 2 anode electrode surface area.

M. Bernt et al., J. Electrochem. Soc. 165, 2018, F305-F314, describe the production of catalyst-coated membranes using a commercially available catalyst composition containing an IrO₂ supported on TiO₂. The catalyst composition contains iridium (in the form of IrO₂) in a quantity of 75 wt. %. In order to obtain an anode which has the lowest possible iridium content level per unit area, the layer thickness of the anode was reduced. Iridium content levels per unit area in the range of 0.20-5.41 mg iridium/cm² were realized and tested in terms of their efficiency in water electrolysis. While good results were still obtained at content levels of 1-2 mg iridium/cm², content levels of less than 0.5 mg iridium/cm² led to a significant worsening of the efficiency of the water electrolysis due to the low layer thickness of the anode and the resulting inhomogeneous electrode layer. It is therefore proposed in this publication to change the structure or morphology of the catalyst in such a way that there is a lower iridium packing density in the anode and, in this way, reduced iridium content levels of less than 0.5 mg iridium/cm² can be realized with the same layer thickness of the anode (e.g. 4-8 μm).

M. Bernt et al., Chem. Ing. Tech., 2020, 92, no. 1-2, pp. 31-39, mention that a possible approach for reducing the iridium packing density in the anode is to use a support material having a high specific surface area (i.e. high BET surface area) and to disperse the catalytically active metallic iridium or the iridium oxide as finely as possible on this support material. In this context, it is mentioned in the publication that many of the usual support materials of sufficiently high stability, e.g. TiO₂, are electrically non-conductive, and therefore a relatively large quantity of Ir or IrO₂ (>40 wt. %) in the catalyst is required in order to generate as cohesive as possible a network of Ir or IrO₂ nanoparticles on the surface of the electrically non-conductive support material. The publication also describes, as a possible solution approach, that the iridium oxide can be dispersed in nanoparticulate form on an electrically conductive support material, for example an antimony-doped tin oxide.

EP 2 608 297 A1 describes a catalyst for water electrolysis which contains an inorganic oxide acting as a support material and an iridium oxide dispersed on this support material. The oxidic support material is provided in the catalyst in a quantity of 25-70 wt. % and has a BET surface area in the range of 30-200 m²/g.

C. Van Pham et al., Applied Catalysis B: Environmental, 269, 2020, 118762, describe a catalyst for the oxygen evolution reaction of water electrolysis which has a core-shell structure, TiO₂ forming the core and IrO₂ the shell. The core-shell catalyst particles contain 50 wt. % IrO₂. Via X-ray diffraction and the Scherrer equation, an average crystallite size of 10 nm is determined for the IrO₂ shell. Catalyst-coated membranes are produced, the anode of which has an iridium content level per unit area of 1.2 mg iridium/cm² or 0.4 mg iridium/cm².

EP 2 608 298 A1 describes a catalyst containing (i) a support material having a core-shell structure and (ii) metallic nanoparticles dispersed on this core-shell support. The catalyst is used for fuel cells.

An object of the present invention is to provide a coated membrane which can be used as a membrane electrode assembly in acidic water electrolysis and enables an efficient oxygen evolution reaction on the coating functioning as the anode. In particular, the coated membrane should enable high activity at a low iridium content.

The object is achieved by a coated membrane containing
a membrane with a front and a rear face,
a catalyst-containing coating which is provided on the front face of the membrane,
   the catalyst containing
      a support material which has a BET surface area of maximally 80 m²/g,
      an iridium-containing coating which is provided on the support material and contains an iridium oxide, an iridium hydroxide or an iridium hydroxide oxide or a mixture of at least two of these iridium compounds,
   wherein the catalyst contains iridium in a quantity of maximally 60 wt. %, and
   the catalyst-containing coating provided on the membrane front face has an iridium content of maximally 0.4 mg iridium/cm².

Due to the above-mentioned properties of the catalyst (i.e. BET surface area of the support material of maximally 80 m²/g and iridium content of maximally 60 wt. %) in combination with a very low iridium content (maximally 0.4 mg iridium per cm 2 membrane) of the catalyst-containing coating provided on the membrane front face, this coating functions, in water electrolysis, as a very efficient anode which has a high activity at a low iridium content.

The catalyst-containing coating provided on the membrane front face is also referred to below as membrane coating, while the iridium-containing coating provided on the support material is also referred to below as support material coating.

As is known to a person skilled in the art, the value for the iridium content of the membrane coating is produced by dividing the mass (in [mg]) of the iridium provided in the membrane coating by the area (in [cm²]) of the membrane which is covered with the membrane coating.

The membrane coating preferably has an iridium content of maximally 0.3 mg iridium/cm², more preferably less than 0.20 mg iridium/cm². For example, the iridium content of the membrane coating is in the range from 0.01 to 0.4 mg iridium/cm², more preferably 0.02 to 0.3 mg iridium/cm², even more preferably 0.03 to <0.20 mg iridium/cm².

The membrane coating has, for example, a thickness in the range from 2 μm to 10 μm, more preferably 3 μm to 8 μm, even more preferably 3 μm to 7 μm.

Preferably, the membrane coating (and thus also the catalyst) does not contain any metallic iridium (i.e. iridium in the oxidation state 0). The iridium in the membrane coating is preferably provided exclusively as iridium in the oxidation state +3 (iridium(III)) and/or as iridium in the oxidation state +4 (iridium (IV)). The oxidation state of the iridium, and thus the absence of iridium(0) and the presence of iridium(III) and/or iridium(IV), can be verified by XPS (X-ray photoelectron spectroscopy). It is further preferred that the iridium of the membrane coating is provided exclusively as an iridium-containing coating on the support material.

The catalyst preferably contains iridium in an amount of maximally 40 wt. %, more preferably maximally 35 wt. %. For example, the catalyst contains iridium in a quantity of 5 wt. % to 60 wt. %, more preferably 5 wt. % to 40 wt. %, even more preferably 5 wt. % to 35 wt. %.

Typically, the support material and thus also the catalyst are particulate.

The support material preferably has a BET surface area of maximally 65 m²/g, more preferably maximally 50 m²/g. For example, the BET surface area of the support material is in the range of 2-80 m²/g, more preferably 2-65 m²/g, even more preferably 2-50 m²/g. In a preferred embodiment, the BET surface area of the support material is 2 m²/g to 40 m²/g, more preferably 2 m²/g to <10 m²/g, even more preferably 2 m²/g to 9 m²/g.

For the efficiency of the catalyst with respect to the oxygen evolution reaction, it can be advantageous if the iridium-containing coating provided on the particulate support material has an average layer thickness in the range from 1.0 nm to 5.0 nm, more preferably 1.5 nm to 4.0 nm, even more preferably 1.7 nm to 3.5 nm. The layer thickness can be adjusted by the quantity of iridium oxide, iridium hydroxide or iridium hydroxide oxide which is deposited on the support material, and the BET surface area of the support material. The higher the BET surface area of the support material at a certain quantity of applied iridium oxide, iridium hydroxide or iridium hydroxide oxide, the lower the layer thickness of the iridium-containing support material coating. The average thickness of the iridium-containing coating provided on the support material is determined by transmission electron microscopy (TEM). The iridium-containing coating on the support material preferably has a relatively uniform layer thickness. For example, the average layer thickness varies locally by a factor of maximally 2. The relative standard deviation from the average layer thickness is preferably maximally 35%. As is generally known, the relative standard deviation StAbwᵣₑₗ (in %), sometimes also referred to as coefficient of variation, results from the following relationship:

StAbwᵣₑₗ=[StAbw/MW]×100

where

MW is the average value of the measured variable, i.e. in the present case the average layer thickness in nm, and

StAbw is the standard deviation, in nm, from the average layer thickness.

The catalyst preferably has a core-shell structure in which the support material forms the core, and the iridium-containing coating forms the shell. Preferably, the core is completely enclosed by the shell.

In an exemplary embodiment, the support material has a BET surface area in the range from 2-65 m²/g, the catalyst contains 5 wt. % to 40 wt. % iridium, and the iridium content level of the catalyst-containing coating provided on the membrane is 0.02 to 0.3 mg iridium/cm². In this preferred embodiment, the average thickness of the iridium-containing support material coating is, for example, in the range from 1.5 nm to 4.0 nm, more preferably 1.7 nm to 3.5 nm.

In a further exemplary embodiment, the support material has a BET surface area in the range from 2-35 m²/g, the catalyst contains 5 wt. % to 35 wt. % iridium, and the iridium content level of the catalyst-containing coating provided on the membrane is 0.03 to <0.20 mg iridium/cm². In this preferred embodiment, the thickness of the iridium-containing support material coating is, for example, in the range from 1.5 nm to 4.0 nm, more preferably 1.7 nm to 3.5 nm.

In a further exemplary embodiment, the support material has a BET surface area in the range from 2 m²/g to <10 m²/g, more preferably 2 m²/g to 9 m²/g, the catalyst contains 5 wt. % to 20 wt. %, more preferably 5 wt. % to 14 wt. % iridium, and the iridium content level of the catalyst-containing coating provided on the membrane is 0.03 to <0.20 mg iridium/cm². In this preferred embodiment, the thickness of the iridium-containing support material coating is, for example, in the range from 1.5 nm to 4.0 nm, more preferably 1.7 nm to 3.5 nm.

For the efficiency of the catalyst with respect to the oxygen evolution reaction, it can be advantageous if the iridium content of the catalyst satisfies the following condition:

(1.003 (g/m²)×BET)/(1+0.0117 (g/m²)×BET)≤Ir-G≤(5.015 (g/m²)×BET)/(1+0.0585 (g/m²)×BET)

where

BET is the BET surface area, in m²/g, of the support material, and Ir-G is the iridium content, in wt. %, of the catalyst.

If, for example, a support material having a BET surface area of 10 m²/g is used, it follows from the above-mentioned condition that an iridium content in the range from 9-32 wt. % is to be selected for the catalyst.

In a preferred embodiment, the iridium content of the catalyst satisfies the following condition:

(1.705 (g/m²)×BET)/(1+0.0199 (g/m²)×BET)≤Ir-G≤(3.511 (g/m²)×BET)/(1+0.0410 (g/m²)×BET)

where

BET is the BET surface area, in m²/g, of the support material, and Ir-G is the iridium content, in wt. %, of the catalyst.

Even more preferably, the iridium content of the catalyst satisfies the following condition:

(1.805 (g/m²)×BET)/(1+0.0211 (g/m²)×BET)≤Ir-G≤(3.009 (g/m²)×BET)/(1+0.0351 (g/m²)×BET)

where

BET is the BET surface area, in m²/g, of the support material, and Ir-G is the iridium content, in wt. %, of the catalyst.

The iridium-containing coating provided on the support material preferably contains an iridium hydroxide oxide. In addition to oxide anions, an iridium hydroxide oxide also contains hydroxide anions and can be described, for example, by the following formula: IrO(OH)x, 1≤x<2.

For example, in the iridium-containing coating provided on the support material, there is an atomic ratio of iridium(IV) to iridium(III), determined by means of X-ray photoelectron spectroscopy (XPS), of maximally 4.7/1.0. For example, the atomic iridium(IV)/iridium(III) ratio in the iridium-containing layer on the support material is in the range from 1.0/1.0 to 4.7/1.0. This can lead to a further improvement in the electrochemical activity of the catalyst. In order to realize an advantageous compromise between high electrochemical activity and high electrical conductivity, it may be preferred for the atomic iridium(IV)/iridium(III) ratio in the iridium-containing layer provided on the support material to be in the range from 1.9/1.0 to 4.7/1.0, more preferably 2.5/1.0 to 4.7/1.0. The atomic iridium(IV)/iridium(III) ratio can be adjusted via the temperature of a thermal treatment of the catalyst. Thermal treatment of the catalyst at high temperature favors high values for the iridium(IV)/iridium(III) ratio. Preferred temperatures for a thermal treatment of the catalyst are also specified below.

An advantageous compromise between sufficiently high electrical conductivity and high electrochemical activity of the catalyst can be achieved, for example, when the catalyst was subjected, during its production, to a thermal treatment at a temperature of more than 250° C., e.g. >250° C. to 550° C., more preferably 300° C. to 450° C., even more preferably 300° C. to 380° C. The thermal treatment can take place, for example, in an oxygen-containing atmosphere. The thermal treatment takes place, for example, over a period of at least one hour, but preferably no more than three hours. As a result of this thermal treatment (preferably at 300-450° C., more preferably at 300-380° C.), the electrical conductivity of the catalyst can be significantly increased compared to a non-thermally treated catalyst (for example by 50 to 100 times), while the electrochemical activity is only moderately reduced (e.g. by 1.5 to 2 times).

The catalyst preferably contains no metallic noble metal (such as platinum, palladium, iridium, rhodium, ruthenium, osmium, silver or gold). Metallic noble metal means a noble metal of oxidation state 0. The absence of metallic noble metals can be verified by XPS.

Optionally, the iridium-containing coating provided on the support material can still contain ruthenium in the oxidation state +3 (Ru(III)) and/or the oxidation state +4 (Ru(IV)).

Suitable support materials on which the iridium-containing coating can be applied are known to a person skilled in the art. For example, the support material is an oxide of a transition metal (for example a titanium oxide (e.g. TiO₂), a zirconium oxide (e.g. ZrO₂), a niobium oxide (e.g. Nb₂O₅), a tantalum oxide (e.g. Ta₂O₅) or a cerium oxide), an oxide of a main group metal (e.g. an aluminum oxide such as Al₂ O₃), SiO₂ or a mixture of two or more of the aforementioned support materials. In a preferred embodiment, the support material is a titanium oxide.

The catalyst is preferably prepared by means of a wet-chemical process in which an iridium oxide, iridium hydroxide or iridium hydroxide oxide is applied to a particulate support material under alkaline conditions and optionally by thermal post-treatment.

Alternatively, it is also possible to deposit the iridium-containing coating on the support material via spray pyrolysis.

For example, the catalyst is prepared by a process in which
an iridium-containing solid is deposited, at a pH≥9, on a support material, in an aqueous medium containing an iridium compound,
the support material loaded with the iridium-containing solid is separated from the aqueous medium and optionally subjected to a thermal treatment.

The support material to be coated is provided in dispersed form in the aqueous medium. The aqueous medium contains an iridium compound which can be precipitated under alkaline conditions as an iridium-containing solid. Such iridium compounds are known to a person skilled in the art. This is preferably an iridium(IV) or an iridium(III) compound.

As already mentioned above, the layer thickness of the support material coating can be adjusted by the quantity of iridium oxide, iridium hydroxide or iridium hydroxide oxide which is deposited on the support material, and the BET surface area of the support material. The higher the BET surface area of the support material at a certain quantity of applied iridium oxide, iridium hydroxide or iridium hydroxide oxide, the lower the layer thickness of the iridium-containing coating on the support material.

Suitable iridium(III) or iridium(IV) compounds which precipitate as solid under alkaline conditions in aqueous solution are known to a person skilled in the art. For example, the iridium(III) or iridium(IV) compound is a salt (e.g. an iridium halide such as IrCl₃ or IrCl₄; a salt whose anion is a chloro complex IrCl₆²⁻; an iridium nitrate or an iridium acetate) or an iridium-containing acid, e.g. H₂IrCl₆. In a preferred embodiment, the aqueous medium contains an iridium(IV) halide, in particular Ir(IV) chloride.

Optionally, a ruthenium(III) and/or ruthenium(IV) compound can also be provided in the aqueous medium. This enables the deposition of an iridium-ruthenium hydroxide oxide on the support material. If a ruthenium precursor compound is provided in the aqueous medium, it may be, for example, an Ru(III) or Ru(IV) salt, for example a halide, nitrate or acetate salt.

Preferably, the aqueous medium for the deposition of the iridium-containing solid on the support material has a pH≥10, more preferably ≥11. For example, the aqueous medium has a pH of 9-14, more preferably 10-14 or 11-14.

The aqueous medium typically contains water in a proportion of at least 50 vol. %, more preferably at least 70 vol. % or even at least 90 vol. %.

For the deposition of the iridium-containing solid on the support material, the temperature of the aqueous medium is, for example, 40° C. to 100° C., more preferably 60° C. to 80° C.

The support material can, for example, be dispersed in an aqueous medium which already contains one or more iridium(III) and/or iridium(IV) compounds but has a pH<9 (e.g. at room temperature). Subsequently, the pH of the aqueous medium is increased to a value 9 by adding a base, and the temperature of the aqueous medium is optionally also increased until an iridium-containing solid is deposited on the support material via a precipitation reaction. Alternatively, it is also possible, for example, to disperse the support material in an aqueous medium which does not yet contain any iridium compounds, and to add an iridium(III) and/or iridium(IV) compound to the aqueous medium only after an appropriate pH and optionally a specific precipitation temperature have been set.

If a ruthenium(III) and/or ruthenium(IV) compound was also provided in the aqueous medium, the solid applied to the support material by the precipitation contains ruthenium in addition to iridium. The atomic ratio of iridium to ruthenium can be, for example, in the range from 90/10 to 10/90.

The separation of the support material, laden with the iridium-containing solid, from the aqueous medium is achieved by methods known to a person skilled in the art (for example by filtration).

The support material laden with the iridium-containing solid is dried. The dried iridium-containing solid which is provided on the support material is, for example, an iridium hydroxide oxide. In addition to oxide anions, an iridium hydroxide oxide also contains hydroxide anions and can be described, for example, by the following formula: IrO(OH)x, 1≤x<2.

As already explained above, the electrical conductivity of the iridium-containing coating provided on the support material, and thus of the catalyst, can be improved if a thermal post-treatment takes place at a somewhat higher temperature. An advantageous compromise between sufficiently high electrical conductivity and high electrochemical activity of the catalyst can be achieved, for example, when the coated support material is subjected to thermal treatment at a temperature of more than 250° C., e.g. >250° C. to 550° C., more preferably 300° C. to 450° C., even more preferably 300° C. to 380° C. The thermal treatment can take place, for example, in an oxygen-containing atmosphere. The thermal treatment takes place, for example, over a period of at least one hour, but preferably no more than three hours.

The coating provided on the membrane preferably contains an ionomer in addition to the catalyst. Suitable ionomers are known to a person skilled in the art. For example, the ionomer is a polymer which contains sulfonic acid group-containing monomers; in particular a copolymer which contains a tetrafluoroethylene and a sulfonic acid group-containing fluorovinyl ether as monomers. The coating provided on the membrane contains the ionomer for example in a quantity of 2 wt. % to 20 wt. %.

Suitable membranes which can be used for PEM water electrolysis are known to a person skilled in the art. For example, the membrane contains a polymer which contains sulfonic acid group-containing monomers; in particular a copolymer which contains a tetrafluoroethylene and a sulfonic acid group-containing fluorovinyl ether as monomers. An overview of suitable polymers for the membrane can be found, for example, in the following publication: A. Kusoglu and A. Z. Weber in Chem. Rev., 2017, 117, pp. 987-1104.

The catalyst-containing membrane coating can be applied to the membrane via customary methods known to a person skilled in the art. For example, an ink containing the catalyst composition and optionally an ionomer can be applied directly to the membrane, so that the coated membrane is obtained after appropriate drying. Alternatively, in what is known as a decal process, the catalyst-containing coating can first be applied to a support film or decal film and then transferred from the decal film to the membrane by pressure and sufficiently high temperature.

If the coated membrane described above is used as a membrane electrode assembly in a water electrolysis cell, the above-described catalyst-containing coating on the front face of the membrane acts as an anode, at which the oxygen evolution reaction takes place.

A coating which contains a catalyst for the hydrogen evolution reaction (HER catalyst) can be applied on the rear face of the membrane. Suitable HER catalysts (for example a catalyst containing a support material and a noble metal applied thereon) are known to a person skilled in the art.

The present invention further relates to a water electrolysis cell containing the coated membrane described above.

Measurement Methods

The following measurement methods were used in the context of the present invention:

### Average Thickness of the Iridium-Containing Support Material Coating

The average thickness of the iridium-containing coating on the support material was determined by TEM (transmission electron microscopy). The average thickness results from the arithmetic mean of the layer thicknesses of the iridium-containing coating determined at at least ten different points on at least two TEM images.

A few μg of the material to be investigated were suspended in ethanol. Subsequently, a drop of the suspension was pipetted onto a carbon perforated film-coated Cu platelet (Plano, 200 mesh) and dried. The layer thickness measurements were taken at a magnification of 500,000×. By means of a parallel EDX element analysis of an element (e.g. Ti) provided in the support material and of Ir, it can be seen on the TEM image which regions on the support material particles are iridium-containing.

The thickness of the iridium-containing coating was determined on at least two TEM images in each case at at least 5 points of the TEM image. Each TEM image shows a plurality of particles. The arithmetic mean of these layer thicknesses yielded the average thickness of the iridium-containing coating.

The relative standard deviation StAbwᵣₑₗ (in %), sometimes also referred to as coefficient of variation, from the average layer thickness results in a known manner from the following relationship:

StAbwᵣₑₗ=[StAbw/MW]×100

where
MW is the average layer thickness, in nm, and
StAbw is the standard deviation, in nm, from the average layer thickness.

The (absolute) standard deviation, in nm, results in a known manner via the square root of the variance.

### Iridium Content

The iridium content and, if present, the ruthenium content, are determined via optical emission spectrometry with inductively coupled plasma (ICP-OES).

### BET Surface Area

The BET surface area was determined with nitrogen as adsorbate at 77 K according to the BET theory (multipoint method, ISO 9277:2010).

### Atomic Ratio of Ir(IV) to Ir(III)

The relative proportions of the Ir atoms of the oxidation state +4 and of the oxidation state +3, and thus the atomic Ir(IV)/Ir(III) ratio in the supported iridium hydroxide oxide were determined by X-ray photoelectron spectroscopy (XPS). The determination of this ratio is carried out in the detail spectrum of the Ir(4f) doublet (BE 75-55 eV, Al-kα source) by an asymmetrical PeakFit—Shirley background, Gauss-Lorentz mixture with 30% Gaussian fraction and a tailoring factor of 0.7. In addition, the presence of an IrOH species in the O(1s) detail spectrum (BE approx. 531 eV, Al-kα source) is likewise detected by means of an asymmetrical PeakFit (Shirley background, Gauss-Lorentz mixture with 30% Gaussian fraction). A corresponding procedure is described, for example, in Abbott et al., Chem. Mater, 2016, 6591-6604.

Via XPS analysis, it is also possible to check whether iridium(0) is present in the composition.

### Thickness of the Catalyst-Containing Membrane Coating

The thickness of the catalyst-containing membrane coating is determined by examining a cross section of a catalyst-coated membrane by means of a scanning electron microscope. The SEM analysis was carried out at an acceleration voltage of 5 to 15 kV.

The invention is explained in more detail on the basis of the following examples.

### EXAMPLES

### Preparation of the Catalysts Used in the Examples

Catalyst 1 (“Cat-1”)

124.56 g iridium(IV) chloride (Ira hydrate, Heraeus Deutschland GmbH & Co. KG) were dissolved in 4000 ml of water at room temperature. Subsequently, 60.17 g TiO₂ (P25, Evonik, BET surface area: 60 m²/g) were added. The pH was adjusted to 9.7 by adding NaOH. The aqueous medium was heated to 70° C. and the pH was adjusted to 11. The mixture was stirred at 70° C. overnight. The pH was kept at 11. The TiO₂ support material laden with the iridium-containing solid was filtered off, washed and dried. A one-hour thermal post-treatment at 350° C. in an oxygen-containing atmosphere was carried out. The XPS analysis showed that the dried iridium-containing solid provided on the support is an iridium hydroxide oxide.

Catalyst 2 (“Cat-2”)

27.80 g iridium(IV) chloride (Ira hydrate, Heraeus Deutschland GmbH & Co. KG) were dissolved in 4000 ml of water at room temperature. Subsequently, 29.94 g TiO₂ (DT20, Tronox, BET surface area: 20 m²/g) were added. The pH was adjusted to 10.3 by adding NaOH. The aqueous medium was heated to 70° C. and the pH was again adjusted to 11. The mixture was stirred at 70° C. overnight. The pH was kept at >11.0. The TiO₂ support material laden with the iridium-containing solid was filtered off, washed and dried. A one-hour thermal post-treatment at 350° C. in an oxygen-containing atmosphere was carried out. The XPS analysis showed that the dried iridium-containing solid provided on the support is an iridium hydroxide oxide.

### Catalyst 3 (“Cat-3”)

A commercially available catalyst was used. This catalyst contains, as support material, TiO₂ coated with IrO₂.

### Catalyst 4 (“Cat-4”)

48.35 g iridium(IV) chloride (Ira hydrate, Heraeus Deutschland GmbH & Co. KG) were dissolved in 4000 ml of water at room temperature. Subsequently, 51.9 g TiO₂ (Active G5, Tronox, BET surface area: 150 m²/g) were added. The pH was adjusted to 11.2 by adding NaOH. The aqueous medium was heated to 70° C. and the pH was adjusted to >9.0. The mixture was stirred at 70° C. overnight. The pH was kept at >9.0. The TiO₂ support material laden with the iridium-containing solid was filtered off, washed and dried. A one-hour thermal post-treatment at 350° C. in an oxygen-containing atmosphere was carried out. The XPS analysis showed that the dried iridium-containing solid provided on the support is an iridium hydroxide oxide.

The iridium content of the catalysts and the BET surface areas of the support materials are summarized in Table 1 below.

TABLE 1
Iridium content of the catalysts and BET
surface areas of the support materials

| | Iridium content of the | BET surface area of the |
|---|---|---|
| Example | composition [wt. %] | support material [m²/g] |
| Cat-1 | 45 | 60 |
| Cat-2 | 30 | 20 |
| Cat-3 | 75 | n/a |
| Cat-4 | 30 | 150 |

### Preparation of Coated Membrane and Determination of the Activity

Each of the catalysts Cat-1 to Cat-4 was dispersed in a liquid phase together with a fluorinated ionomer. In all of the dispersions prepared, the same ionomer and the same solvent were used.

The dispersions were each applied to a transfer film (decal film). After 5 minutes of drying at 110° C., the material was transferred from the transfer film to a membrane (Nafion® NR212, Chemours, USA). The transfer was carried out at a temperature of 170° C. and a pressure of 1.5 MPa (duration: 1 minute). The material which was transferred to the membrane and contained one of the catalysts Cat-1 to Cat-4 functions as an anode.

Furthermore, a cathode was applied on the membrane via the decal process. The cathode was identical in all examples and contained a platinum supported on a carbon and a fluorinated ionomer.

Anode, membrane and cathode together form the membrane electrode assembly (“catalyst-coated membrane” CCM). In the examples EB1-EB3 according to the invention, described in more detail below, and the comparative examples VB1-VB3, these membrane electrode assemblies differ only by their anodes.

In a first test series (example EB1 according to the invention and comparative example VB1), the efficiency of a CCM was measured in a single cell having an active surface area of 25 cm². The cell consisted of platinized titanium plates having a bar-like flow field (“column bar flow field” design) on the anode and cathode side. An uncoated titanium sinter (1 mm thickness) was used in each case as a porous transport layer on the anode side and on the cathode side. In this test series, the catalysts Cat-2 (example EB1 according to the invention) and Cat-4 (comparative example VB1 1) were used.

In a second test series (examples EB2-EB3 according to the invention and comparative examples VB2-VB3), the efficiency of a CCM was measured in a single cell having an active surface area of 5 cm². The cell consisted of gold-plated titanium plates having a serpentine flow field (“single serpentine flow field” design) on the anode and cathode side. In each case, a gold-coated titanium sinter was used as a porous transport layer on the anode side. In this test series, the catalysts Cat-1 (example EB2 according to the invention), Cat-2 (example EB3 according to the invention and comparative example VB3) and Cat-3 (comparative example VB2) were used.

In all the test series a carbon paper (Toray TGP-H-120) was used on the cathode side as the gas diffusion layer. De-ionized water having a conductivity of less than 1 μS/cm was circulated on the anode side. The cell was heated from room temperature to 60° C. within 20 min. Subsequently, the temperature was increased to 80° C. within 20 min.

In the first test series (EB1, VB1), the conditioning was carried out by holding a current density of 1 A/cm² for 1 hour and then cycling ten times between 0 and 1 A/cm² with a holding time of 5 min for each step. At the end of the conditioning, the cell was held at 1 A/cm² for 10 min. Current-voltage characteristics (polarization curves) were recorded at 80° C., 65° C. and 50° C. by increasing the current density from small to large values (A/cm²) with a holding time of 10 min in each case. The steps were, in detail: 0.01-0.02-0.03-0.05-0.08-0.1-0.2-0.4-0.6-0.8-1.0-1.2-1.4-1.6-1.8-2.0-2.25-2.5-2.75-3.0. (A/cm² in each case)

In the second test series (EB2-EB3, VB2-VB3), the conditioning was carried out by holding a current density of 1 A/cm² for 30 minutes. Current-voltage characteristics (polarization curves) were recorded at 80° C., by increasing the current density from small to large values (A/cm²) with a holding time of 5 min in each case. The steps were, in detail: 0.01-0.02-0.03-0.05-0.1-0.2-0.3-0.6-1.0-1.5-2.0-2.5-3.0-3.5-4.0-4.5-5.0-5.5-6.0 (A/cm² in each case). In this case, the first two current-voltage characteristics were still considered as part of the conditioning, while the third current-voltage characteristics are shown as measurement curves in FIG. 2.

Layer thickness of the anode, iridium content level in the anode and electrochemical activities of examples EB1 and VB1 are summarized in Table 2. For the sake of improved clarity, the properties of the catalyst provided in the anode are also indicated again in Table 2 (see also Table 1 above).

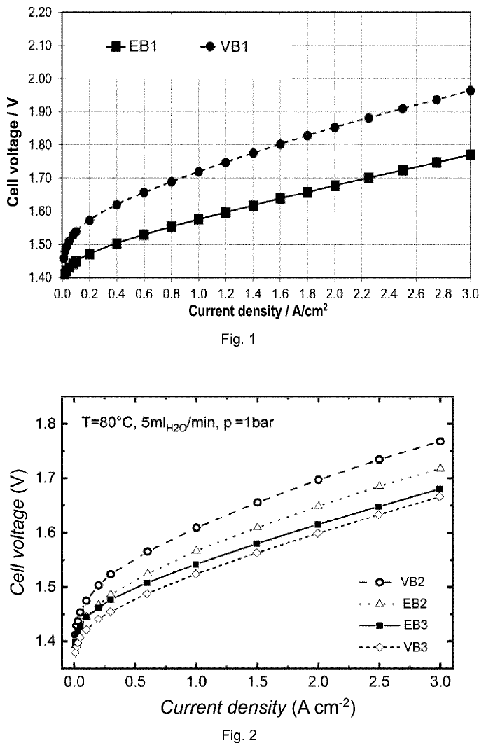

FIG. 1 shows the measurement curves for the membrane electrode assemblies of examples EB1 and VB1.

TABLE 2
Properties of the coated membrane (use of an uncoated titanium
sinter as porous transport layer)

| | | Properties of the | | | | |
|---|---|---|---|---|---|---|
| | | catalyst provided in | | | | |
| | | the anode | | | | |
| | | | BET | | Iridium | |
| | | | surface | | content | |
| | | Iridium | area of | Layer | level in | |
| | Catalyst | content | the | thickness | the | Activity |
| | provided | of the | support | of the | anode | at 1.45 |
| | in the | catalyst | material | anode | [mg | V_{iR-free} |
| Example | anode | [wt. %] | [m²/g] | [μm] | Ir/cm²] | [A/g Ir] |
| EB1 | Cat-2 | 30 | 20 | 6.4 | 0.23 | 614 |
| VB1 | Cat-4 | 30 | 150 | 5 | 0.18 | 52 |

Both in EB1 and in VB1, the iridium content of the anode was less than 0.4 mg iridium/cm². However, in VB1 the support material of the catalyst provided in the anode had a high BET surface area of more than 80 m²/g. The membrane electrode assembly of example EB1 according to the invention (BET surface area of the support material <80 m²/g) surprisingly had a significantly higher electrochemical activity compared to comparative example VB1.

Layer thickness of the anode, iridium content level of the anode and electrochemical activities of examples EB2-EB3 and VB2-VB3 are summarized in Table 3. For the sake of improved clarity, the properties of the catalyst provided in the anode are also indicated again in Table 3 (see also Table 1 above).

FIG. 2 shows the measurement curves for the membrane electrode assemblies of examples EB2-EB3 and VB2-VB3.

TABLE 3
Properties of the coated membrane (use of a gold-coated
titanium sinter as porous transport layer)

| | | Properties of the | | | | |
|---|---|---|---|---|---|---|
| | | catalyst provided | | | | |
| | | in the anode | | | | |
| | | | BET | | | |
| | | | surface | | Iridium | |
| | | Iridium | area of | Layer | content | |
| | Catalyst | content | the | thickness | level in | Activity |
| | provided | of the | support | of the | the anode | at 1.45 |
| | in the | catalyst | material | anode | [mg | V_{iR-free} |
| Example | anode | [wt. %] | [m²/g] | [μm] | Ir/cm²] | [A/g Ir] |
| EB2 | Cat-1 | 45 | 60 | 6.5 | 0.3 | 705 |
| EB3 | Cat-2 | 30 | 20 | 3.6 | 0.13 | 1940 |
| VB2 | Cat-3 | 75 | n/a | 10 | 2.3 | 30 |
| VB3 | Cat-2 | 30 | 20 | 18 | 0.65 | 614 |

In the example EB3 according to the invention and comparative example VB3, the anode contained the same catalyst (iridium content of the catalyst: 30 wt. %; BET surface area of the support material: 20 m²/g). However, the anode of comparative example VB3 had a high iridium content of more than 0.4 mg Ir/cm². The membrane electrode assembly of example EB3 according to the invention (iridium content of the anode <0.4 mg Ir/cm²) surprisingly showed a significantly higher electrochemical activity compared with the comparative example VB3.

The results show that the coated membranes according to the invention exhibit very high activity in the oxygen evolution reaction of the water electrolysis.

1. Coated membrane containing
a membrane with a front and a rear face,
a catalyst-containing coating which is provided on the front face of the membrane,
the catalyst containing
a support material which has a BET surface area of maximally 80 m²/g,
an iridium-containing coating which is provided on the support material and contains an iridium oxide, an iridium hydroxide or an iridium hydroxide oxide or a mixture of at least two of these iridium compounds,
wherein the catalyst contains iridium in a quantity of maximally 60 wt. %, and
the coating provided on the membrane front face has an iridium content of maximally 0.4 mg iridium/cm².

2. Coated membrane according to claim 1, wherein the iridium content of the coating provided on the membrane front face is maximally 0.3 mg iridium/cm², more preferably <0.20 mg iridium/cm².

3. Coated membrane according to either claim 1 or claim 2, wherein the catalyst contains the iridium in an amount of maximally 40 wt. %, more preferably maximally 35 wt. %.

4. Coated membrane according to any of the preceding claims, wherein the support material has a BET surface area of maximally 65 m²/g, more preferably maximally 50 m²/g, even more preferably in the range from 2 m²/g to 40 m²/g.

5. Coated membrane according to any of the preceding claims, wherein the iridium-containing coating provided on the support material has an average layer thickness in the range from 1.0 nm to 5.0 nm, more preferably 1.5 nm to 4.0 nm, even more preferably 1.7 nm to 3.5 nm.

6. Coated membrane according to any of the preceding claims, wherein the support material has a BET surface area in the range from 2-35 m²/g, the catalyst contains 5 wt. % to 35 wt. % iridium, and the iridium content level of the catalyst-containing coating provided on the membrane front face is 0.03 to <0.20 mg iridium/cm².

7. Coated membrane according to any of the preceding claims, wherein the BET surface area of the support material and the iridium content of the catalyst satisfy the following condition:
(1.003 (g/m²)×BET)/(1+0.0117 (g/m²)×BET)≤Ir-G≤(5.015 (g/m²)×BET)/(1+0.0585 (g/m²)×BET)
where
BET is the BET surface area, in m²/g, of the support material, and Ir-G is the iridium content, in wt. %, of the catalyst.

8. Coated membrane according to any of the preceding claims, wherein the catalyst has a core-shell structure in which the support material forms the core, and the iridium-containing coating forms the shell.

9. Coated membrane according to any of the preceding claims, wherein the iridium is provided exclusively as iridium in the oxidation state +3 (iridium(III)) and/or as iridium in the oxidation state +4 (iridium(IV)); and/or wherein in the iridium-containing coating an atomic ratio of iridium(IV) to iridium(III) is provided, determined by means of X-ray photoelectron spectroscopy (XPS), of maximally 4.7/1.0.

10. Coated membrane according to any of the preceding claims, wherein the support material is an oxide of a transition metal, an oxide of a main group metal, SiO₂ or a mixture of two or more of the aforementioned support materials.

11. Coated membrane according to any of the preceding claims, wherein the coating provided on the membrane front face has a thickness in the range of 2 μm to 10 μm, more preferably 3 μm to 8 μm, even more preferably 3 μm to 7 μm.

12. Coated membrane according to any of the preceding claims, wherein the coating provided on the membrane front face contains an ionomer, in particular a polymer which contains sulfonic acid group-containing monomers.

13. Coated membrane according to any of the preceding claims, wherein a coating containing a catalyst for the hydrogen evolution reaction is applied to the rear face of the membrane.

14. Use of the coated membrane according to any of claims 1-13 as a membrane electrode assembly for water electrolysis.

15. Water electrolysis cell containing the coated membrane according to any of claims 1-13.
